(19) United States
(12) Patent Application Publication
(10) Pub. No.: US 2024/0394818 A1
(43) Pub. Date: Nov. 28, 2024

(54) ONLINE HIGHER EDUCATION SYSTEM

(71) Applicant: FEDERALNOYE GOSUDARSTVENNOYE BYUDZHETNOYE OBRAZOVATELNOYE UCHREZHDENIYE VYSSHEGO OBRAZOVANIYA, g. Togliatti (RU)

(72) Inventors: Mikhail Mikhailovich KRISHTAL, g. Togliatti (RU); Roman Vasilevich BOYUR, g. Togliatti (RU); Elmira Sergeevna BABOSHINA, g. Togliatti (RU); Anton Igorevich KUTUZOV, g. Togliatti (RU); Tatyana Aleksandrovna SOKOLOVA, g. Togliatti (RU); Marina Andreevna DROZDOVA, g. Togliatti (RU); Elena Anatolevna REPINA, g. Togliatti (RU); Oksana Petrovna DENISOVA, g. Togliatti (RU); Anna Vladimirovna BOGDANOVA, g. Togliatti (RU); Leila Rafailevna KHAMIDULLOVA, g. Togliatti (RU); Rebiyat Magomedovna GASANOVA, g. Togliatti (RU)

(21) Appl. No.: 18/570,739

(22) PCT Filed: Jul. 14, 2022
(86) PCT No.: PCT/RU2022/050222

§ 371 Date: Jul. 22, 2024

(30) Foreign Application Priority Data
Jun. 19, 2021 (RU) 2021117849

(51) Int. Cl. G06Q 50/20

(52) U.S. Cl. CPC G06Q 50/205

(57) ABSTRACT

An online higher education system, which comprises mutually interacting subsystems (a marketing and applicant attraction subsystem, a remote admission subsystem, a training process planning subsystem, a training process support and academic performance record subsystem, a remote training subsystem, a data integrity control subsystem, a training content development subsystem, a training analytics subsystem), which are integrated by a common IT infrastructure including interfaces for interaction with external systems and at least three databases (content, tutors, students), wherein the subsystems are software and hardware complexes which include data acquisition, processing, transmitting means, as well as mutual interconnection means.

### CROSS-REFERENCE TO RELATED APPLICATIONS

The present application is the U.S. National Phase of PCT/RU2022/050222, filed on 14 Jul. 2022, which claims priority to Russian Patent Application No. 2021117849, filed on 19 Jun. 2021, the entire contents of which are incorporated herein by reference.

### BACKGROUND

### Field

This invention relates to an online higher education system covering all stages—from marketing and attracting applicants to addressing needs indirectly related to educational process—issuing certificates, accounting for medical certificates, academic leaves, etc.

### Related Art

Modern education has rapidly developed by virtue of information technologies in education and pedagogy. Information technology has made it possible to solve one of the main problems of education—the problem of accessibility. Now it is not necessary to attend an educational institution to gain knowledge. Everyone can get an education through remote training and open universities. Due to their “virtual” nature, these systems make education real for people who cannot get it due to large distance from cultural centers, busyness or health problems.

Information technologies also open up new opportunities for local educational institutions in their competition with educational institutions in large cities.

Software developed to support remote education should provide a student with a comprehensive set of tools that allow them to study individually. Such tools include testing and self-testing, systems of final tests, as well as systems that provide information support in accordance with curricula.

Remote admission and training techniques constitute a complex of interrelated processes and resources. Having systematized the processes and roles of participants in an educational system, it is possible to identify the main processes to be implemented within the framework of remote admission and training:
Organizational-admission of applicants, implementation of the movement of students, document management and formation of documents on graduation.
Pedagogical-building educational trajectories, knowledge transfer, providing conditions for gaining practical skills and experience.
Training management-managing groups of students, assigning training and testing and measurement activities.
Monitoring the quality of training.
Development and maintenance-content development, advisory and technical support for the operability of information resources and the system as a whole, development of a remote training system in accordance with emerging needs.

Various training systems are known from patent literature, some of which are disclosed e.g., in patent publications RU 2186423 C2; U.S. Pat. No. 5,437,555 A.

Prior art training system is described in publication RU 2186423 C2, IPC G09B 7/00 (2000.01), 2020. The invention relates to automated training and knowledge testing tools. The system is a computer technology for remote testing of regional participants from a Center. The system comprises serially connected blocks of preparatory modules, testing modules, telecommunication modules and analysis and processing modules.

Disadvantageously, the system cannot provide training materials which are dynamically modified based on each user's test results while they study the training materials.

Prior art training system is described in publication U.S. Pat. No. 5,437,555 A (IPC G09B5/14; G09B7/04; G09B7/00, 1995), which is a training system with an interactive communication between students and a tutor who receives student grade reports. Training curriculum is generated taking into account the rate at which students master the training material.

### Disadvantages:

1. The system cannot test each user during training at respective predetermined stages and cannot provide test results for each user.

2. The training system cannot test each student in a class and dynamically modify the training material based on the testing.

3. It cannot provide training services using modified material.

Thus, the above-mentioned training systems cannot provide educational services with modified training materials in response to academic performance, learning rate or achievements of each student.

“Remote Training System” developed by Japanese scientists Hoyashita Shigeru, Ikegami Yasuyuki, Sumi Kazuhiro presents a relatively novel approach to the implementation of remote education, which is shown in FIG. 1. It follows from this figure that, in the simplest case, the remote training system may consist of the following training providing means:
test transmission means,
grading means,
grade transmission means,
optimization means,
dynamic modification means,
selection means,
intermediary means,
request transmission means,
user support means, and
registration means.

Besides, the system includes a training material database, which has a property of updatability. User interacts with the system by means of a network. An important component of such a system is constituted by user support subsystem elements, which are available for interaction at any time during a user's work with the system. (see Patent RU 2272324, IPC G09B 7/00 (2006.01), G09B 5/08 (2006.01), G06F 17/20 (2006.01), 2005).

Disadvantage: The training system described in the patent can provide training services with training materials being modified only in response to understanding, learning rate or achievements of each student. The system cannot promptly modify the training materials with regard to student support when student status changes, as well as training curricula, student practice programs, submission of term papers and final qualifying papers.

Problems of implementation and organization of online admission and training.

At initial stages of development and implementation of online admission and training techniques in educational activities, a set of problems arises. It should be noted that the problems that arise are mainly related to an insufficiently well-developed strategy of information technologies implementation in educational activities, and, first of all, these are:
lack of concept of the project as a whole;
lack of performance criteria for project stages;
lack of a clear responsibility allocation among members of implementation team;
lack of interest to and possibility of reengineering of existing business processes of an educational institution;
lack of motivational factors in place;
unresolved issues of project funding;
disloyalty of potential users to the system, primarily among academic staff, low level of training in IT;
lack of competencies to create effective electronic educational resources; and
incomplete set of administrative acts which regulate activities using information and communication technologies.

The choice of an online admission and training platform or system is also important. Taking into account the aforementioned, prior to organizing and implementing an online admission and training system in the educational process, it is necessary to achieve a number of technical tasks as follows:
creation of a hardware and software complex which functions in an information network of institutions and provides unified access to educational resources;
creation of specialized information and educational environments and online training courses in various competencies;
development of methodological criteria, quality control means and systems for online training, development and reproduction of methodological materials, programs, online training courses, and their support;
improvement of communication and technological infrastructure for the implementation of educational techniques; and
development of methods and tools for monitoring and controlling the quality and efficiency of training.

Each educational institution has its own specificities and principles for achieving online training tasks. At the stage technological platform selection, it is necessary to evaluate existing products on the market in terms of their application to achieve tasks and objectives.

The following are fundamental criteria for online admission and training system selection:
system functionality which is stipulated by a complex of necessary services and functional capabilities to achieve the tasks;
modularity, compilation of educational programs from individual modules, which ensures generating an individual trajectory of education and development;
support for international standards, which enables the purchase of ready-made professional training programs, blocks, and uploading them into an operational electronic training system at no additional cost;
cross-platform character, which enables flexible interaction between the online admission and training system and the users regardless of characteristics of information and communication devices and software with which users access the system;
multimedia features for using, as content, not only text, hypertext and graphic files, but also audio, video files, animations and 3D graphics;
a knowledge testing program which comprises a wide variety of open and closed type test tasks, and software services that enable real time evaluation of students' knowledge;
flexible system adjustment which enables maintaining the operability of the system, troubleshooting by specialists of in-house support service; and
system scalability which enables the expansion of the scope of functional capabilities of the system depending on emerging needs and possibilities of application in training.

One may name the following advantages of online admission and training:
easier access to information when choosing a future occupation;
flexibility of training process;
independence on geographical location;
possibility of using the latest inventions of scientific and technological progress in the educational process; and
self-control of training rate, i.e., a student determines the rate of training by him/herself, may return to certain lessons, or may skip certain sections, etc.

No similar solutions have been revealed in the known prior art.

All prior art cited above has the following disadvantages:
none is intended for automation of the entire process of online admission and training in the context of higher education from the initial stage of attracting applicants and up to the state final certification.
none provides for means for attracting applicants and remote admission while, in reality, the process of interaction with future students starts from these particular stages;
prior art remote training systems lack means for quality (consistency) control of large amounts of data. Without these means, the system devolves into chaos;
there is no operational analysis of training behavior to evaluate the quality and modify contents; and
database integrity assurance system is not described.

### SUMMARY

To remedy the above-mentioned deficiencies of prior art solutions, technical means for online higher education system have been developed and implemented. Being interconnected, the technical means of the system are capable of providing a full range of online access and training for users: applicants, students, tutors, including not only those involved in the process of training, but also those indirectly related to the training and influencing the educational process.

The second problem solved by the claimed invention consists in combining various technical means of the online higher education system to improve the quality of assessment, stimulation and activation of creative potential of students and, when in use, to accompany the training.

The third problem solved by this invention consists in ensuring the integrity of the system and reconciliation of various requirements for the processes of admission and training and for the results to be obtained by virtue of digitalization and unification of all means which are provided as software and hardware complexes.

Reference signs:
RTT—remote training techniques;
CPE—continuing professional education;
IS—information system;
EP—educational portal;
OT—online training;
PC—personal computer;
MA—applicant member area;
AC—admission Committee;
TD—Testing Department;
EPSM—educational process support management;
MC—Marketing Center;
CNIT—Center for New Information Technologies;
LMS Moodle—electronic training system “Moodle”;
BP—business process developed in a CRM system;
CRM (Customer Relationship Management) system—application software;
software within IC-Bitrix: Corporate Portal, designed for automation of interaction with clients (applicants, students);
IVR (Interactive Voice Response)—a system of pre-recorded voice;
messages that performs the function of routing phone calls within the Contact Center;
IS “Galaktika ERP” is an enterprise management information system. It has a component structure consisting of functional modules;
IS “Bitrix24”—an information system that implements the functionality of the corporate web portal, for organizing group or individual work of authorized users;
IC—individual curriculum;
BC—basic curriculum;
CC—current curriculum;
CSE—content structural elements;
TS (in load calculation and distribution control unit);
Activities—tasks, events;
Lead generation—ensuring an incoming flow of digital twins of potential applicants and transfer students;
Lead (target lead)—a potential client;
FC—final certification;
BIRT—a report generation system distributed under an open license (https://www.eclipse.org/birt/);
RTS—remote training system;
BPMS—Business Process Management System, business process management systems—technological software for automated management of processes described in a formal language (for example, BPMN);

The above technical problems posed are solved by virtue of the fact that an online Higher Education System has been developed, which comprises interacting subsystems:
Marketing and applicant attraction subsystem,
Remote admission subsystem,
Training process planning subsystem,
Training process support and academic performance record subsystem,
Remote training subsystem,
Data integrity control subsystem,

which are combined in a common IT infrastructure including interfaces for interaction with external systems and at least three databases (content, tutors, students); wherein the subsystems are software and hardware complexes which include data acquisition, processing, transmitting means, as well as mutual interconnection means.

The system may further include a training content production subsystem.

The system may further include a training analytics subsystem and a digital footprint database.

The subsystems which constitute the system are interconnected as follows:
The marketing and applicant attraction subsystem has its output connected to the remote admission subsystem and the training process planning subsystem;
The remote admission subsystem has its output connected to the training process support and academic performance record subsystem, the training process planning subsystem and the remote training subsystem;
The training process support and academic performance record subsystem and the training process planning subsystem are integrated by means of a two-way communication, wherein the output of the training process planning subsystem is connected to the remote training subsystem, and the output of said subsystem is connected to the training process support and academic performance record subsystem;
The training process support and academic performance record subsystem has its output connected to the external users of the system;
The remote training subsystem has its output connected to the external users of the system;
The data integrity control subsystem is connected to all subsystems.

The subsystems included in the system are connected to the further subsystems as follows:
the training process planning subsystem has its output connected to the training content production subsystem, which has its output connected to the remote training subsystem via the content database;
the training process support and academic performance record system is connected to the training analytics subsystem by means of a two-way communication;
a second input of the training analytics subsystem is connected to the remote training subsystem via the digital footprint database;
the input of the training content production subsystem is connected to the second output of the training analytics subsystem;
wherein the data integrity control subsystem is connected to the inputs and outputs of all subsystems.

The marketing and applicant attraction subsystem includes:
an advertising campaign management unit having its output connected to the lead generation unit;
a lead processing unit having its input connected to the lead generation unit and the external lead generation unit;
the output of the lead processing unit is connected to a telephone interaction control unit and an e-mail interaction control unit, which has its output connected to the lead processing unit;
the output of the telephone interaction control unit is connected to a “low-quality lead” status assignment device and a lead to contact conversion device, wherein the units and the devices of the subsystem are coupled to specialist automated workstations (AWS).

The remote admission subsystem comprises:
a competition unit which includes multiple competition test units with data acquisition, processing and transmission means, which has its input connected to means for receiving and processing all incoming applications from potential applicants;
a transfer student unit with data acquisition, processing and transmission means.

wherein the data processing units and means of the subsystem are connected to the automated workstations (AWS) of specialists.

The training process planning subsystem includes:
a BC and groups register management unit, which has its input connected by means of a two-way communication with the IC generation management unit and is connected, in combination with the output of the IC generation management unit, to optional/elective courses registration and FC planning management units,
outputs of optional/elective courses registration and FC planning management units are connected to the TS load calculation and distribution control unit,
output of the TS load calculation and distribution control unit is connected to the schedule generation and integrity checking control unit,
the output of the BC and groups register management unit is coupled to the BC development/actualization management and group making unit, output of which is coupled to a BC and group correspondence management unit,

wherein the subsystem units are coupled to specialist automated workstations (AWS).

The training process support and academic performance record subsystem includes:
a voice inquiry processing unit coupled by its output to the request classification unit;
the outputs of the request classification unit are coupled to three units, namely a consultation providing unit, a document generation and issuance unit, and a position change unit;
the position change unit has its input coupled to a transcript and exam sheet generation unit, and has its output coupled to the document generation and issuance unit,

wherein the subsystem units are coupled to specialist automated workstations (AWS).

The remote training subsystem includes a content access grant unit, which has its output coupled to multiple activity (task, event) access units, which have their outputs coupled to grade calculation units, wherein the subsystem units are coupled to specialist automated workstations (AWS).

The data integrity control subsystem includes a data mirroring unit of a unified corporate information model, and a data integrity rule meta description unit, each of which has its output coupled to a data integrity rule periodic control unit, which has its output coupled to a data integrity problem visualization unit, wherein the subsystem units are coupled to specialist automated workstations (AWS).

The training content development subsystem includes:
a production schedule generation unit which has its output coupled to multiple content type assignment units of each of the multiple content development units,
each of the content type assignment units has its output coupled to the CSE content generation unit of the corresponding CSE development unit;
the CSE content generation unit has its output coupled to the CSE correction unit, which has its output coupled to a CSE media content generation unit and a content packaging unit,

wherein the subsystem units are coupled to specialist automated workstations (AWS).

The training analytics subsystem includes:
a data analysis unit, which receives as input a corresponding digital footprint, the first output of said unit being coupled to the data collection and sorting unit, and the second output being coupled to the decision making data preparation unit;
the decision making data preparation unit has its input coupled to the data collection and sorting units and student feedback analysis units, and have their output is coupled to an algorithm validation and processing unit,

wherein the subsystem units are coupled to specialist automated workstations (AWS).

Information acquisition, processing and transmission means may be provided in the form of telephones, tablets, personal computers, laptops, and are not restricted to this list.

The IT infrastructure includes physical and virtual servers, personal computers, Wi-Fi and other communication channels, network equipment, and system software.

Means for ensuring the mutual interconnection of software and hardware complexes of all subsystems may be implemented in the form of an integration bus, a set of two-way gateways, a BPMS based external orchestrator, and are not restricted to this list.

The technical result from using all essential features of the claimed invention consists in improved efficiency and quality of the continuous online training process by virtue of digitalization of all processes and connections between the means of the online training system, from the admission of students and up to the graduation of qualified specialists.

The technical result from using all essential features of the claimed invention consists in the fact that the created online higher education system enables quick responses to changes in user status, curricula, faster receipt of high-quality training material when curriculum changes, ensuring the tracking of correctness of changes made to databases and reconciling changes made to any of the subsystems with data related to the modified parameter in other subsystems.

The marketing and applicant attraction subsystem enables the process of lead generation, i.e., ensuring an incoming flow of digital twins of potential applicants and transfer students. Within the subsystem, “leads” (unconfirmed contact information) are processed, they are converted into “contacts” (confirmed contact information about an individual interested in admission/transfer), and contacts are transferred to the remote admission subsystem, which ensures a quick response to a change in the user status.

The remote admission subsystem manages the educational institution admission process by converting and transferring digital twins of applicants and transfer students between its units, which also allows for a quick response to a change in the user status.

The training process planning subsystem provides the remote training subsystem with all necessary information to provide access to contents and events by transmitting to the latter the training events schedule and current curricula (CC), thus enabling a quick response to changes in the user status, curricula. Each single CC record represents related information about: who (student), when (dates within the semester), studies what (content), with whom (tutor), where (in which LMS) and for what reason (BC, IC, academic backlog, grade improvement, etc.).

To generate such information, the subsystem units process information about last year's BC register and training groups, adjust the register based on data on the demand for educational programs on the market, generate data on individual curricula of the students and their enrollment in elective courses and electives. The final CC is generated in the TS load calculation and distribution control unit.

The training process support and academic performance record subsystem receives, as input, two different types of data. The first type is requests from students, which are processed in order to structure them and convert them into one of three types-ones which require consulting, ones which require processing and issuing an official document, and ones which require performing any position changes. Operation of this unit results in the changes being reflected in the digital twin of the student, as well as in information on the issued documents appearing in the database.

The second type of data input in the subsystem results from periodic summing up of training results in accordance with the training process schedules-“examination periods”, in which data on test scores accumulated by the students are converted into data on academic performance, and under certain conditions into position changes based on the examination period results, including expulsions and graduations.

The remote training subsystem enables and organizes the process of remote training, while improving the efficiency and quality of the continuous online training process by virtue of digitalization of all processes and connections between the means of the online training system. Input information about students' accounts, their current curricula, ready-to-post contents, and the schedule of training events is transformed into a system for the students and tutors to access the contents stored in databases, as well as to all training tasks and activities included therein. The result of operation of the subsystem is a digital footprint collected on the basis of all participants' actions, as well as an assessment of content coverage in grades, which is integrated based on the results of events and tasks completion.

The data integrity control subsystem stores meta descriptions and a mirror copy of all data that is processed in other subsystems of the online training system. Being input with dynamic data and a set of integrity rules for this data, the subsystem optimizes the data for processing speed and periodically checks the rules using algorithms stored in a formalized manner in the subsystem's database. The output of the subsystem is a set of analytical reports output to the AWS of managers who are responsible for data integrity in various subsystems.

The training content development subsystem provides and organizes the process of providing the training process with electronic training materials (contents ready to be placed in the LMS). Input source data of academic schedules, basic, individual and current curricula, are converted into a temporal content production and actualization schedule, which is then transmitted to the multiple parallel content development units.

The content development unit assigns the contents to a certain type, thereby dividing the content into an ordered plurality of content structure elements (CSE). Each of the CSE is developed in a CSE development unit, in which digital data (in particular, text, audio and video files) is processed, which is then packaged into a consolidated single content.

The training analytics subsystem processes a cohort digital footprint of all student training activities, while automatically detecting patterns in these data, clustering them and highlighting models of learning behaviors. The resulting output of the subsystem operation is a set of possible scenarios for student support, as well as analytical information on how difficult it is to study a given educational product for students involved in it.

The digital footprint database provides for accumulation of information from all student training events.

Course unit contents databases, tutors, students databases allow for asynchronous communications between subsystems.

Development of an online higher education system which comprises interacting subsystems (a marketing and applicant attraction subsystem, a remote admission subsystem, a training process planning subsystem, a training process support and academic performance record subsystem, a remote training subsystem, a data integrity control subsystem, a training content development subsystem, a training analytics subsystem), combined within a common IT infrastructure, which includes interfaces for interaction with external systems and at least three databases (contents, tutors, students), wherein the subsystems are software and hardware complexes that include means for data acquisition, processing and transmission, as well as and interconnection therebetween, ensures an increase in the efficiency and quality of the continuous process of admission, online training and graduation of students.

Besides, both the students and the tutors are enabled to quickly respond to changes in curricula and training materials, and the process of obtaining high-quality training material in case of changing curricula becomes quicker. Also, system integrity and rapid detection of data inconsistencies in individual subsystems are ensured by tracking the correctness of changes made to the database and coordination of operations of all online education providing means with regard to the changes made and with a variable parameter in other means.

### BRIEF DESCRIPTION OF THE DRAWINGS

FIG. 1 is a general diagram of the online higher education system, which includes the subsystems according to the independent claim;

FIG. 2 is a general diagram of the online higher education system, which includes the training content development subsystem and the training analytics subsystem;

FIG. 3 is a diagram of the software and hardware complex of the marketing and applicant attraction subsystem;

FIG. 4 is a diagram of the software and hardware complex of the remote admission subsystem;

FIG. 5 is a diagram of the software and hardware complex of the training process planning subsystem;

FIG. 6 is a diagram of the software and hardware complex of the training process support and academic performance record subsystem;

FIG. 7 is a diagram of the software and hardware complex of the remote training subsystem;

FIG. 8 is a diagram of the software and hardware complex of the data integrity control subsystem;

FIG. 9 is a diagram of the software and hardware complex of the training content development subsystem; and

FIG. 10 is a diagram of the software and hardware complex of the training analytics subsystem.

### DETAILED DESCRIPTION

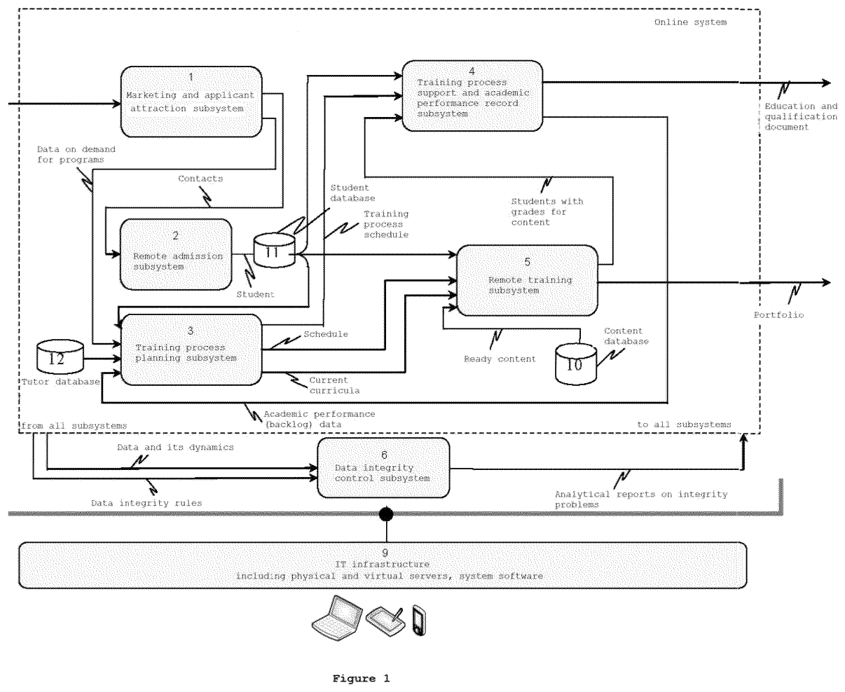

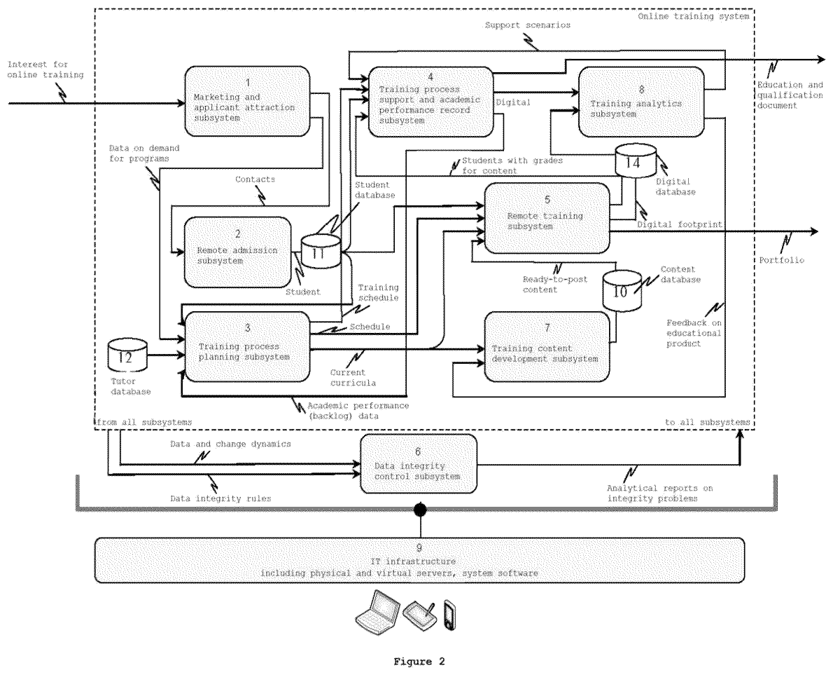

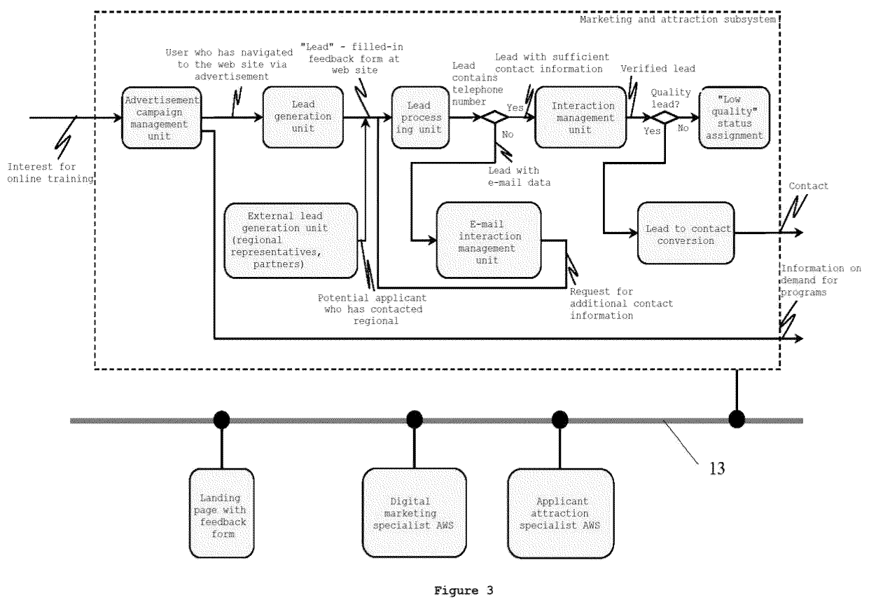

The online training system is a software and hardware complex which consists of interconnected subsystems (see FIGS. 1, 2), and the subsystems consist of interconnected units (see FIGS. 3-10). By providing and organizing all remote training processes, subsystems and their units transform and transmit information: digital twins of real entities, such as applicants, transfer students, students, facts of completing tasks, grades in transcripts, etc.

Operation of each unit results in a significant change in parameters of a digital twin, to an extent that it can be regarded as a separate stage in the life cycle of a real world entity.

Operation of the system is also provided by automated workstations (AWS), which are included in the software and hardware complexes of the subsystems for various roles in the processes. Operation of the AWS is peculiar in that they independently manage the process in accordance with the technical regulations, while requesting the necessary actions from the participants, if necessary.

All subsystems and units of online training subsystems are connected to a single data bus, through which they exchange information. Via the data bus, the data integrity control unit acquires data from all subsystems for constant background monitoring of their integrity, thus providing the operation of the data control manager's AWS with reports on all inconsistencies, and transmits the data necessary for making adjustments to the respective subsystem.

Unit interaction rules are not set rigidly. An example of practical technical implementation is a use of methodology of choreography, wherein each unit directly calls services of another unit it needs via Rest API protocol using intermediary service api.tltsu.ru (Yii, PHP. MySQL). A transition to a more centralized control scheme using an orchestration principle is further conceived, under which only one dedicated service on a bus (BPMN, Camunda) is entitled to call other services.

The developed online higher education system comprises: a marketing and applicant attraction subsystem 1, a remote admission subsystem 2, a training process planning subsystem 3, a training process support and academic performance record subsystem 4, a remote training subsystem 5, a data integrity control subsystem 6, IT infrastructure 9 and a common data bus 13, which provides for mutual interaction of software and hardware complexes of the subsystems, databases, AWS, etc. IT infrastructure 9 includes at least three databases: dynamically modified academic subject contents database 10, database 11 that contains information on students and their status at each stage of online training with regard to the modification of training schedule, student practice programs, submission of term papers and final qualifying papers; tutor database 12, which records data on the tutors, majors of the respective tutors, and contact information of the respective tutors.

The system may include a training content development subsystem 7, a training analytics subsystem 8, the IT infrastructure 9 at the same time including a digital twin database 14.

The databases enable asynchronous communications between the subsystems. The databases may accumulate data outputs from one subsystem and provide the same to an input of another subsystem not immediately but when needed. Use of databases provides a technical method of organization of mutual interaction between subsystems.

All subsystems include units provided in the form of software and hardware complexes which run in servers under control of a software which enables them to perform functions for data acquisition, processing and transmission both among them and for external users, being connected with them by Wi-Fi or via a common data bus 13.

A marketing and applicant attraction subsystem 1 includes:
an advertising campaign management unit having its output connected to the lead generation unit;
a lead processing unit having its input connected to the lead generation unit and the external lead generation unit;
the output of the lead processing unit is connected to a telephone interaction control unit and an e-mail interaction control unit, which has its output connected to the lead processing unit; and
the output of the telephone interaction control unit is connected to a “low-quality lead” status assignment device and a lead to contact conversion device,

wherein the units and the devices of the subsystem are coupled to specialist automated workstations (AWS).

The marketing and applicant attraction subsystem 1 (see FIG. 3) provides for the lead generation process by means of lead generation and external lead generation units, the lead generation process consisting in providing an input flow of digital twins of potential applicants and transfer students. The marketing and applicant attraction subsystem 1 includes an advertising campaign management unit having its output connected to the lead generation unit, which receives information on users that are redirected to the web site e.g., via an advertisement. The output of the lead generation unit provides a “lead” to the lead processing unit via the data bus, the “lead” being a filled-in feedback form provided at the web site. The same unit receives, via Internet protocol, information on potential applicants, which have contacted regional representatives, from the external lead generation unit. The lead processing unit sorts the incoming leads and provides a part of the leads which contain a telephone number and sufficient contact information to the telephone interaction control unit. The second part of the leads which only contain information on e-mail address is directed by the lead processing unit to the e-mail interaction control unit. Said unit provides feedback to the user who has submitted incomplete information, and then returns the corrected lead with complete information to the lead processing unit. The telephone interaction control unit checks the incoming leads and sorts them at its output by providing part of them to a “low-quality lead” status assignment device and providing another part of them to a lead to contact conversion device. Information from all units is provided to specialist automated workstations (AWS) via two-way communications for operators to perform necessary operations.

Mutually interconnected advertising campaign management unit, lead generation unit, lead processing unit, external lead generation unit, telephone interaction control unit, e-mail interaction control unit of the subsystem acquire and process information that is necessary for attracting potential applicants and transfer students, then this information is transformed and provided to potential users. Then the units process the “leads” (unconfirmed contact information), convert them into “contacts” (confirmed contact information on a natural person who is interested in admission/transfer) and transmit the contacts to the remote admission subsystem.

The marketing and applicant attraction subsystem 1 is implemented by means of instantiated AWS integrated by means of the common data bus 13, in the following manner (see FIG. 3):
a landing page with a feedback form (Bitrix CMS),
a digital marketing specialist AWS (advertising clients in Yandex Direct, Google Ads, VK, Pixel), and
an applicant attraction specialist AWS (“Corporate Portal Bitrix24”, CRM module: PHP, MySQL, business processes: Bitrix24, reporting form set: BIRT, virtual Asterisk based ATS: Java).

AWS are operated by means of personal computers, laptops, tablet computers and other known hardware means.

Units of the subsystem 1 are illustrated assuming 100% conversion at each step of information processing. In fact, the amount of information entities at the output of each unit is smaller than their amount at the input. Dissipating data flows are not shown in the diagram.

The marketing and applicant attraction subsystem 1 has its input coupled via a two-way connection to external users, which makes it possible to respond to environmentally arising needs.

Use of the marketing and applicant attraction subsystem 1 (see FIG. 3) provides for resolving the following technological problems arising in the system:
generation of unified reference books of admissions and competitions, lists of entrance tests for each competition, admission control numbers, qualifying grades, admission conditions, etc. Reference data on admissions and competitions may be accumulated on a yearly basis and their dynamics may be analyzed.
simultaneous registration of potential users (applicants) in the system by several operators in real time. The registration procedure ensures the completeness and correctness of potential user (applicant) information input.
automatic generation of a list of entrance tests for each potential user (applicant) in the process of registration, generation of document print forms (potential user's (applicant's) application form, potential user's (applicant's) certificate, exam sheet, acknowledgement of documents receipt etc.), which are provided to the potential user (applicant) and/or included in his/her personal record.
generation of statistical reports on the numbers of potential users (applicants) by faculties, departments, fields and majors of study in real time.
support of entrance tests planning. Support of procedures of analyzing potential users' (applicants') test papers in case of using a test based system of knowledge evaluation.
recording of admission orders and commercial educational services contracts, monitoring payments according to the contracts.

The remote admission subsystem 2 comprises:
a competition unit which includes multiple competition test units with data acquisition, processing and transmission means, which has its input connected to means for receiving and processing all incoming applications from potential applicants; and
a transfer student unit with data acquisition, processing and transmission means,

wherein the data processing units and means of the subsystem are connected to the automated workstations (AWS) of specialists.

The remote admission subsystem 2 manages the process of admission to a higher educational institution by converting the digital twins of applicants and transfer students and transmitting them between its units.

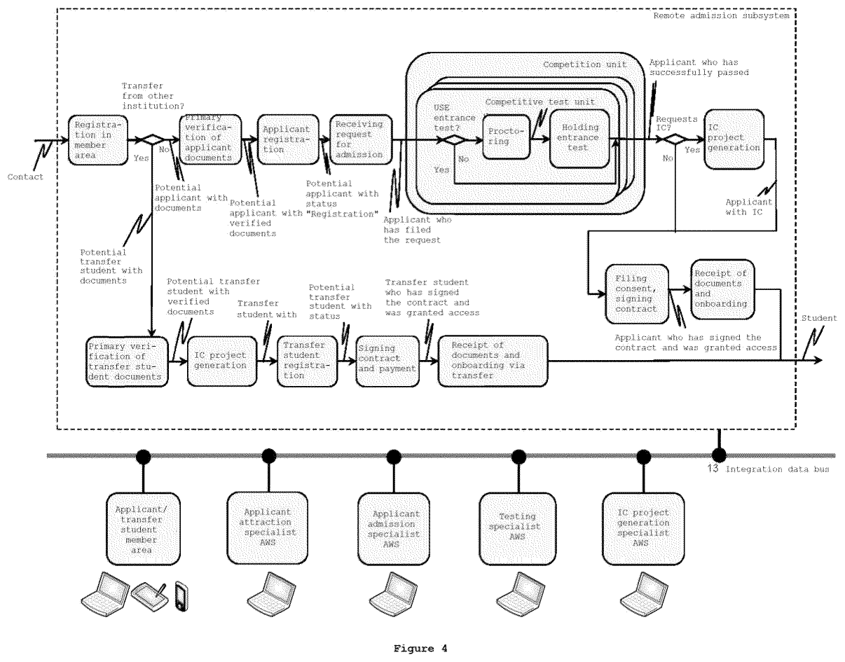

The remote admission subsystem 2 includes instantiated AWS which are integrated by means of a common data bus 12 as follows (practical implementation example, see FIG. 4):
Applicant/transfer student member area MA (based on CMS Bitrix Website Management: PHP, MySQL);
Applicant attraction specialist AWS (“Corporate Portal Bitrix24”, CRM module: PHP, MySQL, business processes: Bitrix24, reporting form set BIRT, Asterisk based virtual ATS: Java)
Applicant admission specialist AWS (ERP system “Galaktika-VUZ”, “Admission Campaign” module: Oracle, Atlantis, “Corporate Portal Bitrix24”, CRM module: PHP, MySQL, business processes: Bitrix24, reporting form set BIRT);
Testing specialist AWS (“Educational Web Portal”: PHP, Oracle); and
IC project generation specialist AWS (reporting form set: BIRT, Microsoft Excel, educational web portal functionality unit).

AWS operation is carried out by means of personal computers, laptops, tablets and other known hardware means.

Units of the remote admission subsystem 2 are described assuming 100% conversion at each information processing step. In fact, the amount of information entities at the output of each unit is smaller than their amount at the input. Dissipating data flows are not shown in the diagram.

Remote admission subsystem 2 comprises a competition unit which includes multiple competition test units and data acquisition, processing and transmission means. The competition unit has its input connected to the following means for receiving and processing all incoming applications from potential applicants:

A contact provided from the lead to contact conversion unit of the marketing subsystem provides for registering in the member area, thus creating multiple applicant member areas. Contacts from the member areas are sorted into primary contacts and those of “transfer students” from other educational institutions. Primary contacts are assigned a potential applicant status, and they are provided by the information receiving means to the information processing means for processing documents and applicant onboarding. Then information on the potential applicant with “onboarding” status is provided to the information transmission means, from which the formalized application for admission is transmitted to the competition unit. The competition unit is capable of checking the incoming information and sorting its flow into contacts which need to take the competition and those to be admitted based on primary information on the mean grade. The competition unit forwards the information on the applicants that have passed the competition to the individual curriculum (IC) project generation means for those in need of the IC, or past said means. Full information on admitted persons is provided to a means that enables signing a contract in the digital form and transmission of admission documents both to the transfer students' member area and to the AWS of the system and assigning a “student” status to the person.

The same formalization routine is applied in parallel to the information on transfer students. The difference is that information on such contacts is not provided to the competition unit but is provided to the means that enables signing a contract in the digital form and transmission of admission documents both to the transfer students' member area and to the AWS of the system and assigning a “student” status to the person.

Units of the remote admission subsystem 2 acquire all data from the MA, applicant attraction specialist AWS, testing specialist AWS, and transmit the processed data to the applicant admission specialist AWS and IC project generation specialist AWS.

The training process control subsystem includes:
a BC and groups register management unit, which has its input connected by means of a two-way communication with the IC generation management unit and is connected, in combination with the output of the IC generation management unit, to optional/elective courses registration and FC planning management units,
outputs of optional/elective courses registration and FC planning management units are connected to the TS load calculation and distribution control unit,
output of the TS load calculation and distribution control unit is connected to the schedule generation and integrity checking control unit, and
the output of the BC and groups register management unit is coupled to the BC development/actualization management and group making unit, output of which is coupled to a BC and group correspondence management unit,

wherein the subsystem units are coupled to specialist automated workstations (AWS).

The training process planning subsystem 3 provides the remote training subsystem with all necessary data for granting access to training contents and events by transmitting to said subsystem the schedule of training events and current curricula (CC). Each single CC entry constitutes related data on who (student), when (dates within the semester) studies what (content), with whom (tutor), where (in what LMS) and for what reason (BC, IC, academic backlog, grade improvement, etc.).

To generate such data, subsystem units automatically process information on last year's BC and training groups register, adjust the register based on data on the demand for educational programs on the market, generate data on individual curricula of the students and their enrollment in elective courses and electives. The final CC is generated in the TS load calculation and distribution control unit.

The training process planning subsystem 3 includes a BC and groups register management unit which is input with data on demand for programs. The BC and groups register management unit is also input with data from the IC generation unit, which is provided with requests for generating ICs by the BC and groups register management unit. The BC and groups register management unit provides a BC development/actualization management and group making unit with data on BCs that need development/actualization and on groups which should be generated in the information system (IS). The BC development/actualization management and group making unit provides a BC and group correspondence management unit with information on fulfilled tasks which had been received from the BC and groups register management unit. Said management unit provides the data on basic curricula and groups that correspond to the standing requirements to three units: the BC development/actualization management and group making unit, the BC and groups register management unit and the IC generation management unit. Thus said units are interconnected by two-way communications, which enables continuous automatic data monitoring and recording.

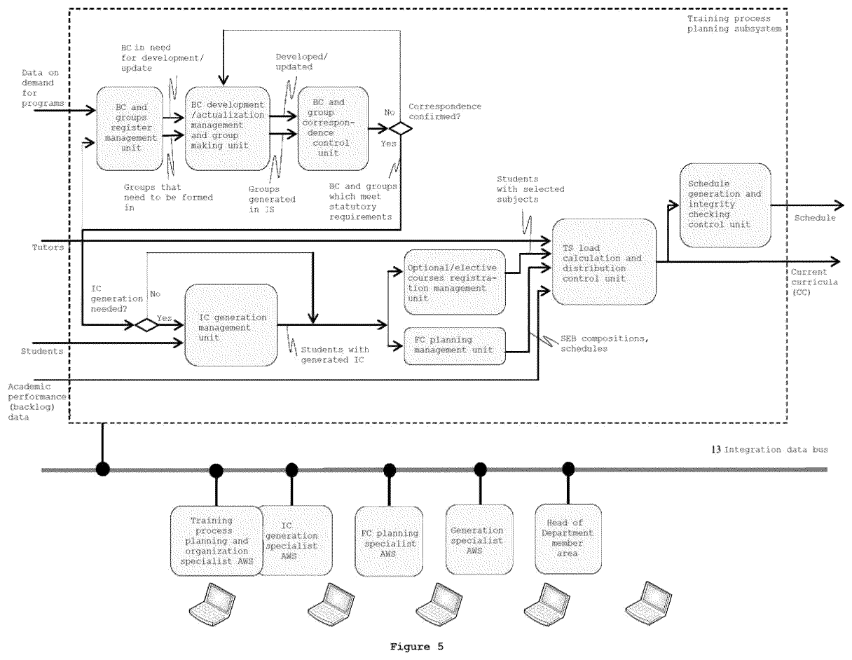

The IC generation management unit has its output coupled to two units: an optional courses registration unit and a final certification (FC) planning management unit, and transmits information on students with generated ICs to these units. The optional/elective courses registration unit transmits data on students with selective subjects to the TS load calculation and distribution control unit, the same unit being also provided with information on the State Examination Board (SEB) staff and final certification (FC) schedules from the FC planning management unit. The TS load calculation and distribution control unit has its output coupled to a schedule generation and integrity checking control unit (see FIG. 5). Said units provide information on schedules and current curricula to the remote training subsystem.

The training process planning subsystem 3 includes instantiated AWS integrated by means of the common data bus 12 as follows (practical example of technical implementation):
training process planning and organization specialist AWS (software complex “Plany”, ERP “Galaktika”, AICS “Kafedry”: Python, PostgreSQL, reporting form set: BIRT);
IC generation specialist AWS (reporting form set: BIRT, Microsoft Excel, IC project import interface from an educational web portal: PHP, Oracle);
SFE planning specialist AWS (software complex “Plany”, ERP “Galaktika”, AICS

“Kafedry”, Microsoft Excel);
schedule generation specialist AWS (software complex “Galaktika.RUZ”, AICS “Kafedry”: Python, PostgreSQL); and
Head of Department member area (AICS “Kafedry”, reporting form set: BIRT).

AWS operation is carried out by means of personal computers, laptops, tablets and other known hardware means.

Training process planning subsystem 3 provides for generating curricula, calculation of loads, and manages the composition of training groups, and provides the remote training subsystem 5 with necessary information (groups, training process schedules, dates of starting and ending of semesters and examination periods, subject lists and respective tutors) for implementing the training process and performing the necessary prescribed activities. The training process planning subsystem 3 provides the training content development subsystem 7 with information on what subjects should be covered by the students in the next semesters for generating the production schedule of content development.

The training process support and academic performance record subsystem 4 is input with two different data types. The first type is requests from the students, which are processed by the request classification unit in order to structure them and convert them into one of three types: ones which require consulting, ones which require processing and issuing an official document, and ones which require performing any position changes. Operation of this unit results in the changes being reflected in the digital twin of the student, as well as in information on the issued documents appearing in the database.

The second type of data input in the subsystem results from periodic summing up of training results in accordance with the training process schedules-“examination periods”. These data are provided to the transcript and exam sheet generation unit in which data on test scores accumulated by the students are converted into data on academic performance, and under certain conditions into position changes in the position change unit based on the examination period results, including expulsions and graduations.

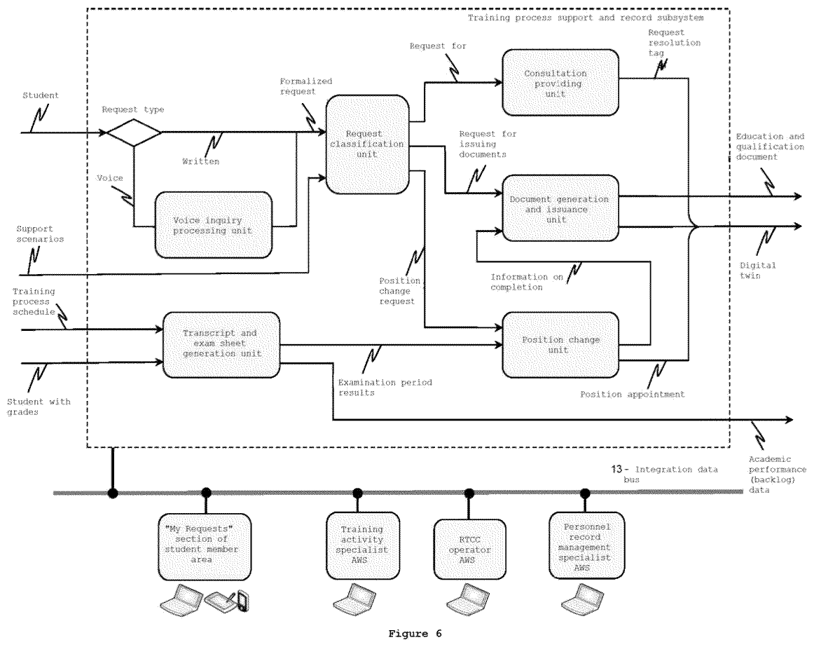

The training process support and academic performance record subsystem 4 includes a voice inquiry processing unit which has its output coupled to the request classification unit. The request classification unit has its output coupled to three units: a consultation providing unit, a document generation and issuance unit, and a position change unit. The input of the position change unit is provided with data processed by the transcript and exam sheet generation unit. Data processed by the position change unit are provided to the input of the document generation and issuance unit. This unit outputs resulting data-digital twins of the students and digital twins of documents associated with the students (see FIG. 6).

The training process support and academic performance record subsystem 4 includes instantiated AWS integrated by means of the common data bus 12 as follows (practical example of technical implementation, see FIG. 6):
Student member area section “My Requests” (LMS Rosdistant, developed on the basis of Moodle: PHP, MySQL),
training activity specialist AWS (“Corporate Portal Bitrix24”, CRM module: PHP, MySQL, business processes: Bitrix24, reporting form set: BIRT, ERP system: Galaktika-VUZ, modules “Student cohort management”, “Student academic performance records”: Oracle, Atlantis),
remote training contact center operator AWS (ERP system: Galaktika-VUZ, module “Student cohort management”: Oracle, Atlantis, “Corporate Portal Bitrix24”, CRM module: PHP, MySQL, business processes: Bitrix24, reporting form set: BIRT, Asterisk based virtual ATS: Java), and
personnel record management specialist AWS (reporting form set: BIRT, ERP system Galaktika-VUZ, modules “Student cohort management”, “Student academic performance records”: Oracle, Atlantis).

AWS operation is carried out by means of personal computers, laptops, tablets and other known hardware means.

The training process support and academic performance record subsystem 4 (see FIG. 1) is input with information from remote admission subsystem 2 about the numbers of newly admitted students and with information on training results from the remote training subsystem 5.

The training process support and academic performance record subsystem 4 carries out the following sub-processes:
current academic performance monitoring;
interim assessment;
transmitting a preliminary test before transmitting content (training material) and user reminders on the need for submitting a response to the preliminary test; and
selection of content (training material) including multiple elements from a pre-created content database based on the result of preliminary test evaluation using said predetermined selection criteria, user needs, user's lecture coverage history, changing user status in the course of training.

Remote training subsystem 5 enables and organizes the process of remote training. Input information on student accounts, their current curricula, ready-to-post contents is provided to the content access grant unit. The schedule of training events is provided to the content study unit. The content study unit is provided by the content access grant unit with information on students having access to contents and on tutors having access to the contents and the students.

The content study unit converts the input information into a system of students' and tutors' access to contents and to all training tasks and events included therein. Operation of the subsystem results in a digital footprint collected on the basis of all activities of the participants, as well as an assessment of content coverage in grades, which is integrated based on the results of events and tasks completion.

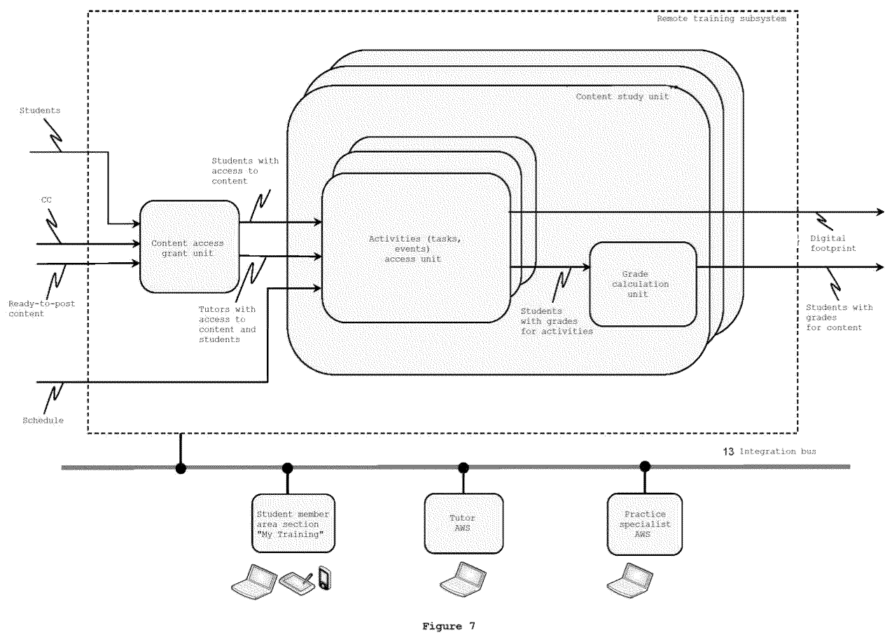

The remote training subsystem 5 includes an academic subject content database and tutors database and student database access grant unit which has its output coupled to activities (tasks, events) access units which have their outputs coupled to grade calculation units (see FIG. 7).

The remote training subsystem 5 is coupled to the instantiated AWS which are integrated by means of the common data bus 12 as follows (practical example of technical implementation, see FIG. 7):
Student member area section “My Training” (developed on the basis of CMS Bitrix Web Site Administration: PHP, MySQL);
tutor AWS (developed on the basis of Corporate Portal Bitrix 24: PHP, MYSQL, RTS: developed on the basis of LMS Moodle, PHP, MySQL); and
student practice specialist AWS (ERP system Galaktika-VUZ: Oracle, Atlantis, “Corporate Portal Bitrix24”, CRM module: PHP, MySQL, reporting form set: BIRT).

AWS operation is carried out by means of personal computers, laptops, tablets and other known hardware means.

Data integrity control subsystem 6 stores meta descriptions and a mirror copy of all data that is processed in other subsystems of the online training system. Being input with dynamic data and a set of integrity rules for this data, the subsystem optimizes the data for processing speed and periodically checks the rules using algorithms stored in a formalized manner in the subsystem's database. The output of the data integrity control subsystem 6 is a set of analytical reports output to the AWS of managers who are responsible for data integrity in various subsystems.

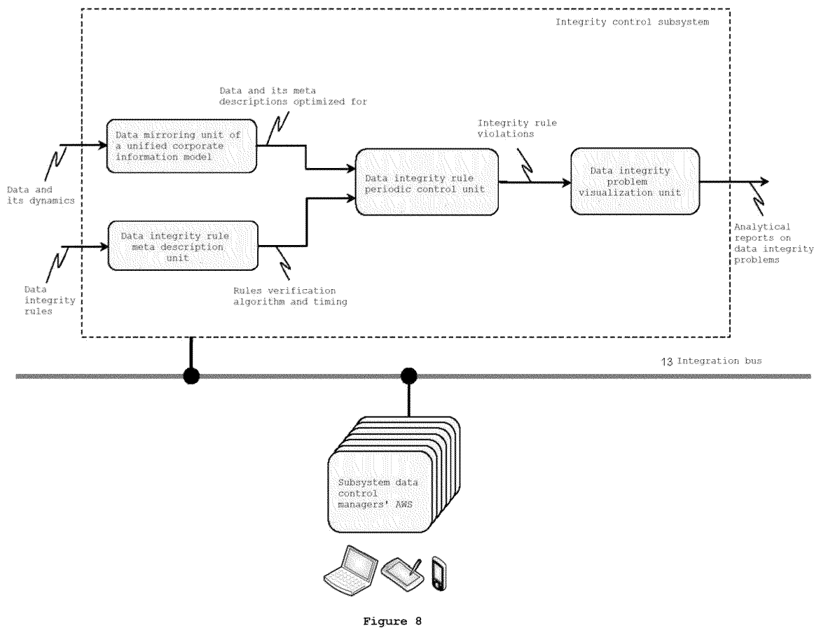

The data integrity control subsystem 6 (for practical example of technical implementation, see FIG. 8) includes a data integrity rule periodic control unit, which is input with data and their meta descriptions, which are optimized for integrity control by a data mirroring unit of a unified corporate information model. The data integrity rule periodic control unit is provided by a data integrity rule meta description unit with information on the rule checking algorithm and timing. The data integrity rule periodic control unit outputs information on integrity rule violations to a data integrity problem visualization unit. The data mirroring unit of the unified corporate information model (a scheme in Oracle DBMS with meta descriptions of all entities and attributes, and mirror copies of data implemented in the form of Oracle view, materialized view or tables, with dblinks passed over into non-Oracle systems (PostrgreSQL, MySQL)) acquires the data and dynamics of their modification from all subsystems. The data integrity rule meta description unit (a scheme in Oracle DBMS, rules are stored in the form of SQL queries) has access to the data integrity rules. The data integrity problem visualization unit transmits data prepared by the data integrity rule periodic control unit in the form of analytic reports on data integrity problems to the AWS of managers who are responsible for data integrity in various subsystems.

The data integrity control subsystem 6 includes AWS of subsystem data integrity control managers: BIRT reporting forms set.

AWS operation is carried out by means of personal computers, laptops, tablets and other known hardware means.

The training content development subsystem 7 enables and organizes the process of providing the training process with electronic training materials (contents ready to be posted in LMS). Input source data of academic schedules, basic, individual and current curricula are converted into a temporal content production and actualization schedule, which is then transmitted to the multiple parallel content development units.

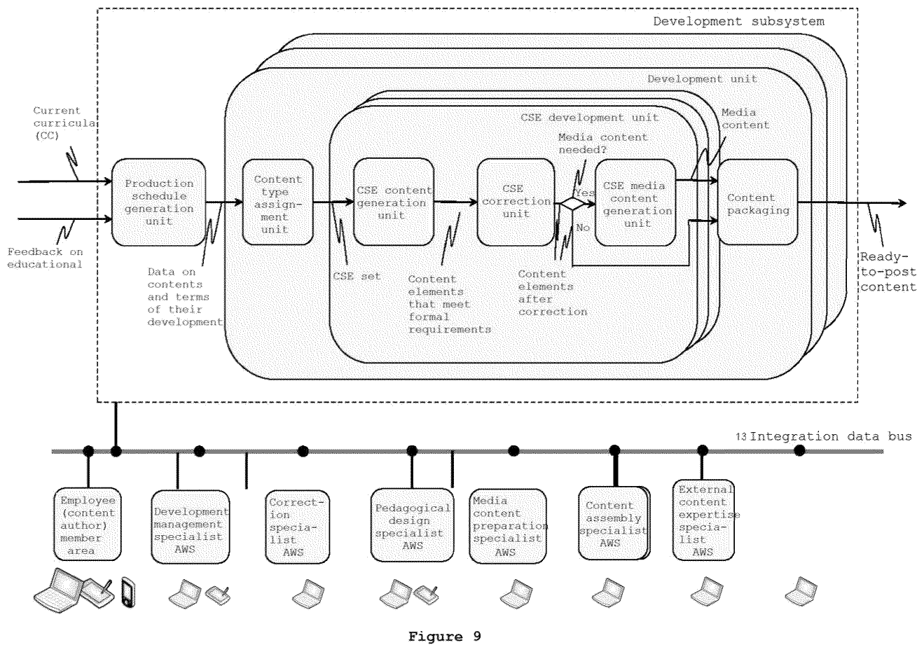

The training content development subsystem 7 (see FIG. 9) includes a production schedule generation unit, from which data on the contents and their development terms are transmitted to a content type assignment unit of each of the multiple content development units. Each content type assignment unit has its output coupled to the CSE content generation unit, to which information on the CSE set is provided. The CSE content generation unit of each CSE development unit transmits content units, which meet the formal requirements, to the CSE correction unit. The CSE correction unit has its output coupled to a CSE media content generation unit and a content packaging unit. The CSE media content generation unit provides media content to the content packaging unit, and the CSE correction unit provides content units after correction to the content packaging unit.

The content development unit assigns the contents to a certain type, thereby dividing the content into an ordered plurality of content structure elements (CSE). Each of the CSE is developed in the CSE development unit, in which digital data (in particular, text, audio and video files) is processed, which is then packaged into a consolidated single content. The developed contents are stored in the training content database 10.

The training content development subsystem 7 includes instantiated AWS which are integrated by means of the common data bus 12 as follows (practical example of technical implementation, see FIG. 9):
Employee (content author) member area (“Corporate Portal Bitrix24”, business processes: Bitrix24, reporting form set: BIRT),
Content development management specialist AWS (“Corporate Portal Bitrix24”, business processes: Bitrix24, reporting form set: BIRT),
Correction specialist AWS (“Corporate Portal Bitrix24”, business processes: Bitrix24, Microsoft Word),
Pedagogical design specialist AWS (“Corporate Portal Bitrix24”, business processes: Bitrix24),
Media content preparation specialist AWS (“Corporate Portal Bitrix24”, business processes: Bitrix24, specialized software for editing audio and video content),
Content assembly specialist AWS (“Corporate Portal Bitrix24”, business processes: Bitrix24, reporting form set: BIRT, electronic training course construction means: iSpring Suite),
Content validation specialist AWS (“Corporate Portal Bitrix24”, business processes: Bitrix24, reporting form set: BIRT, Moodle based LMS), and
External content expertise specialist AWS (Moodle based LMS).

AWS operation is carried out by means of personal computers, laptops, tablets and other known hardware means.

Training analytics subsystem 8 processes the cohort digital footprint of all student training activities, while automatically detecting patterns in these data, clustering them and highlighting models of learning behaviors. The resulting output of the subsystem operation is a set of possible scenarios for student support, as well as analytical information on how difficult it is to study a given educational product for students involved in it.

Operation of the training analytics subsystem is provided by the following AWS:
Pedagogical design specialist AWS (“Corporate Portal Bitrix24”, business processes: Bitrix24, reporting form set: BIRT), and
Data processing manager AWS (MySQL, business processes: Bitrix24, reporting form set: BIRT).

AWS operation is carried out by means of personal computers, laptops, tablets and other known hardware means.

Training analytics subsystem 8 includes a data analysis unit, which is input with a respective digital footprint. The first output of the data analysis unit is coupled to a data collection and sorting unit, to which the data set for modeling and typical models is provided. The second output of the data analysis unit provides the digital twins of the students with the learning role models to a decision making data preparation unit. The decision making data preparation unit is also input with information from a student feedback analysis unit. At its output, the data analysis unit provides a set of possible scenarios to an algorithm validation and processing unit. Data from the training analytics subsystem 8 may be provided to the training content development subsystem 7 and the training process support and academic performance record subsystem 4.

Information acquisition, processing and transmission means may be configured as telephones, tablets, personal computers, laptops, and are not restricted to this list.

The subsystems are integrated in a common IT infrastructure 9 (see FIGS. 1, 2), which includes physical and virtual servers, personal computers, Wi-Fi and other communication channels, networking equipment, system software. All subsystems and units of the online training system are coupled to the common data bus 13, by means of which they exchange information.

Means for ensuring the mutual interconnection of software and hardware complexes of all subsystems may be implemented in the form of an integration bus, a set of two-way gateways, a BPMS based external orchestrator, and are not restricted to this list.

Alongside with the basic operation providing means as mentioned above, each of the subsystems also includes a data integrity control means to continuously monitor the integrity of the modified data in each subsystem and the online higher education system, which means interacts with the data integrity control subsystem 6.

The following is a description of the online higher education system using an exemplary system implemented by the Applicant.

For a student(S) to become connected to the online higher education system, he/she needs at least to know the existence of such system. Therefore, the marketing and applicant attraction subsystem 1 is one of auxiliary means, which is not directly involved in the training process but is still necessary in the claimed invention.

Functions implemented by the software and hardware complex of the marketing and applicant attraction subsystem 1 are: providing an incoming flow of applicants and increasing their number by virtue of brand and reputation management, market positioning, carrying out marketing analysis, managing advertisement campaigns. The marketing and applicant attraction subsystem 1 processes all incoming applications from potential clients via various communication channels:
feedback forms at the web site,
e-mail messages,
live chat messages,
telephone calls,
applications from social networks, and
messengers.

Absolutely all applications are aggregated as “leads” in CRM system Bitrix24, and designated employees are automatically assigned. System functions implementation involves all means of the software and hardware complex of the marketing and applicant attraction subsystem 1. For using the marketing and applicant attraction subsystem 1, an employee desktop interface, which is updated in real time and is a key task management tool, was developed. The advertisement campaign management unit and the external lead generation unit provide for receipt of data which are acquired by search programs on the Internet concerning the most in-demand professions. Besides, using said units, the marketing and applicant attraction subsystem 1 acquires data on all persons who are interested in going into education in the higher educational institution. Two-way communication means of the software and hardware complex of the marketing and applicant attraction subsystem 1 enable the processing of acquired data and development of marketing and advertising strategy. The lead processing unit provides the accumulated and processed information which is related to potential students (applicants) (prepared “leads” (lead, target lead): information on a potential client who has responded in a certain manner to a marketing communication) to the input of the remote admission subsystem 2.

The potential S (applicants) who are willing to be attended to the higher educational institution, post applications at the admission web site (by way of an example, web site www.rosdistant.ru), wherein preliminary check of the application for data completion is carried out. If the application form is not empty, the information transmission means transmits the acquired data from the admittance web site into the CRM of the IS “Corporate Portal Bitrix24”, after which a link for registration in IS “Applicant Member Area” is sent out to the e-mail for instantiating individual Bitrix users.

The potential S (applicant) should take steps in his/her member area so as to pass the whole admission procedure (documents upload, competitive selection, payment, etc.). In the process of passing the procedure, a user account is instantiated in IS “Educational Web Portal”, which corresponds to the potential user (applicant) (his/her name, login and password) to enable the use of information acquisition, processing and transmission means-logging on to the IS “Educational Web Portal” to take the testing.

In the process of passing the admission steps, the remote admission means also instantiates a lead in the CRM module of IS “Corporate Portal Bitrix24” portal.tltsu.ru (Bitrix24 Corporate Portal, MySQL, PHP), which, after being processed by a special Business Process (developed basing on standard Bitrix24.CRM Business Processes), is copied into a Contact. The processing of contacts and leads in Bitrix.CRM is performed by the information acquisition, processing and transmission means in an automatic manner, using procedures of applicant data synchronization from the Applicant MA to Bitrix.CRM.

The contact of potential S (applicant) in Bitrix.CRM has statuses which are automatically assigned in accordance with the passed steps of admission procedure in Applicant MA. At achieving a certain status, applicant data are transmitted in an automatic manner by the information transmission means (by starting a dedicated Business Process) to the “Admission Campaign” module of ERP Galaktika (Oracle, Atlantis). This module includes an integration with other modules of ERP Galaktika for use when receiving Basic Curricula (BC) and price lists for commercial educational services.

Upon achieving a certain status (access to educational environment) the potential S (applicant) is enabled to start training (covering the training materials) before actual admission. For this purpose, the information on the potential S (applicant) with this status is imported using the information transmission means from IS “Educational Web Portal” and from IS “Applicant Member Area” to the IS “User (Student) Member Area”.

The admission process is implemented in a completely remote manner using information acquisition, processing and transmission means (without having to physically visit the higher educational institution): from submitting documents, taking entrance tests, and up to an admission order.

The remote admission subsystem 2 implements the functions of supporting the potential S (applicants and transfer students, i.e. persons who are admitted from other higher educational institutions) at all stages of admission to the higher educational institution, including holding an entrance test, notifying the applicants on the test results, carrying out the procedure of onboarding to the higher educational institution, and generating students' personal records.

The functions of the remote admission subsystem 2 are performed using instantiated AWS integrated by means of the common data bus 13 in the following manner (practical example of technical implementation, see FIG. 4):
Applicant/transfer student member area MA (based on CMS Bitrix Web Site Management: PHP, MySQL);
Applicant attraction specialist AWS (“Corporate Portal Bitrix24”, CRM module: PHP, MySQL, business processes: Bitrix24, reporting form set: BIRT, Asterisk based virtual ATS: Java);
Applicant admission specialist AWS (ERP system Galaktika-VUZ, module “Admission Campaign”: Oracle, Atlantis, “Corporate Portal Bitrix24”, CRM module: PHP. MySQL, business processes: Bitrix24, reporting form set: BIRT);
Testing specialist AWS (“Educational Web Portal”): PHP. Oracle); and
IC project generation specialist AWS (reporting form set: BIRT, Microsoft Excel, educational web portal functionality unit).

The final result of carrying out all procedures by the software and hardware complex of the remote admission subsystem 2 consists in onboarding the applicants in the higher educational institution in accordance with the entrance test results, as well as the combination of admission conditions set forth in the Rules for admission of the higher educational institution, and assigning the trainee (student) status. At each step of functioning of this subsystem, the data integrity and all means operation coherence control unit performs systematic data collection and sorting in case an inconsistency with integrity criteria is detected.

The training process planning subsystem 3 integrates instantiated AWS by means of the common data bus 13 (practical example of technical implementation, see FIG. 5):
Training process planning and organization specialist AWS (software complex “Plany”, ERP “Galaktika”, AICS “Kafedry”: Python, PostgreSQL, reporting form set: BIRT);
IC generation specialist AWS (reporting form set: BIRT, Microsoft Excel, IC project import interface from an educational web portal: PHP, Oracle);
SFE planning specialist AWS (software complex “Plany”, ERP “Galaktika”, AICS “Kafedry”, Microsoft Excel);
Schedule generation specialist AWS (software complex “Galaktika.RUZ”, AICS “Kafedry”: Python, PostgreSQL); and
Head of Department member area (AICS “Kafedry”, reporting form set: BIRT).

Subsystem units process information on last year's BC and training groups register, adjust the register based on data on the demand for educational programs on the market, generate data on individual curricula of the students and their enrollment in elective courses and electives. The final CC is generated in the TS load calculation and distribution control unit.

The training process planning subsystem 3 generates basic, current and individual curricula and transmits information on them via the information transmission means to the remote training subsystem 5 and the training content development subsystem 7.

To enable the functioning of the training process planning subsystem 3 using all above-mentioned units, first a Basic Curriculum (BC) is developed, as well as a BC and groups register for the academic year e.g., using Google Tables. Then BC is composed using special dedicated software “Plany”, from which it is imported in ERP Galaktika.

After BC is uploaded in ERP Galaktika, its data are automatically provided into “Infomodel” system, and the data integrity and all means operation coherence control unit automatically verifies the correctness of the BC data, results of which are reflected in errors or warnings in BC reports. Rules of BC data integrity (verification) have been developed on the basis of Plans and Groups Management Regulations.

Functions which are performed by the software and hardware complex of the training process planning subsystem 3: generation and output of curricula (BC, individual curricula-IC), generation of current curricula, load distribution and composing training groups.

The training process training subsystem 3 transmits data on the composition of the training groups, training process schedules, dates of starting and ending of semesters and examination periods, subjects and tutors to the remote training subsystem 5, and information on what subjects should be covered by the students in the next semesters for the development of training materials to the training content development subsystem 7.

Content development in the training content development subsystem 7 starts with collecting additional information (e.g., information on content developers, lecturers) from the departments and composing a Register of materials for development.

To monitor the terms and quality of training materials development, a respectively named unit is instantiated in IS Corporate Portal Bitrix 24 (Bitrix 24 Corporate Portal, MySQL, PHP), Author and Group Moderators are assigned. Then the composed Register of materials in xls format is automatically uploaded into this group using special scripts, whereby folders are automatically created at the group disk, as well as basic tasks and their sub-tasks in accordance with a certain structure. All developers listed in the Register of materials are automatically added into the group and attached to respective sub-tasks. In the process of uploading, the data integrity and all means operation coherence control means verifies the validity of Register of materials data. If the data are valid, the upload takes place without errors.

Functions performed by the software and hardware complex of the training content development subsystem 7: based on the list of adopted schedules and analysis of state-of-the-art education technologies, it develops new materials, updates and revises the existing ones, including correction, voiceover, recording of video lectures, as well as assembly and registration of ready materials.

The developed contents are uploaded into the database. Optionally, update or revision of existing content (training materials) is performed using a training material dynamic modification means and content (training material) optimization means.

Production of materials makes use of content type assignment units, CSE content generation unit, CSE correction unit, information processing means, which are provided in the form of mutually interconnected audio and video recorders, personal computers, etc.

The training content (training material) development subsystem 7 provides for developing a training course datasheet and developing structural elements of the training course.

The necessary equipment and software for the workstations is as follows:
a personal computer,
a web browser,
e-mail processing software,
office program package (text editor, electronic worksheets); and
software for operations with IS “Bitrix24”.

The technology (procedure) for developing and creating electronic training materials, including test tasks database, as well as instructional guidelines for support (in particular, for holding webinars and practice classes), is based on a sequence of clearly described operations with two-way communications and clear allocation of roles, which provides a new concept of creating training materials in an educational process.

As such, the following roles and functions are allocated:
practical knowledge holder (who is generally not a tutor),
pedagogical designer (whose function is interviewing and translating practical content into texts, infographics and formulas), plagiarism checking,
layout editor,
editor,
audio engineer,
speaker,
video engineer,
operator,
designer, and
video editing.

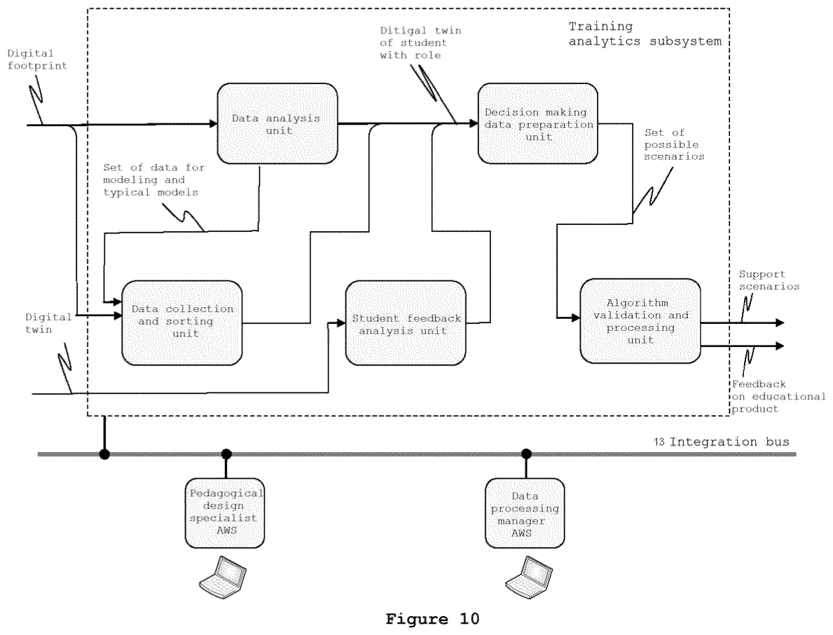

Online training process is carried out in a Moodle based modified LMS, MySQL database. User actions in electronic guidebooks while working with LMS are stored by the analytics data analysis unit and digital footprint collection means (see FIG. 10) in the Learning Records Store (LRS) in accordance with specification Experience API. LRS “Learning Locker” (MongoDB, PHP (Laravel)) is used. Electronic guidebooks are created in iSpring, uploaded with Experience API support indicated, processed by hand-crafted converters (Python), downloaded to IS “Student Member Area”. A ready guidebook is based on HTML5, JavaScript, CSS and media files. When the guidebook is launched a script in IS “Student Member Area” is invoked to acquire data which are necessary for user identification and storing data in the LRS. When the user further works with the guidebook, data on user actions are sent to the LRS in accordance with the specification Experience API by means of Ajax queries.

Resulting grade is generated for the students in accordance with accumulated grades for the training material from the LMS, in the end of the last day of the examination period access to activities submission is closed, and only the possibility to browse the electronic guidebooks is retained.

Functions performed by the software and hardware complex of the training process support and academic performance record subsystem 4 by means of the voice inquiry processing unit, the request classification unit, the consultation providing unit, the document generation and issuance unit, and a position change unit are: providing conditions for student training, attending to incoming requests, supporting position changes, interim assessment and graduation, holding webinars, and standing support of students' training activities by tutors.

Remote training subsystem 5 comprises:
instantiated AWS integrated by means of a common data bus 12 as follows (practical example of technical implementation, see FIG. 7):
Student member area section “My Training” (developed on the basis of CMS Bitrix Web Site Management: PHP, MySQL);
Tutor AWS (developed on the basis of Corporate Portal Bitrix 24: PHP, MySQL, LMS: developed on the basis of LMS Moodle, PHP, MySQL);
Practice specialist AWS (ERP system Galaktica-VUZ: Oracle, Atlantis, “Corporate Portal Bitrix24”, CRM module: PHP, MySQL, reporting form set: BIRT); and
includes an academic subject content database, tutor database, student database access grant unit having its output coupled to the activities (tasks, events) access units, which have their outputs coupled to the grade calculation units (see FIG. 7).

IT infrastructure 9 of the inventive remote training system includes the following databases: academic subject content database 10, tutor database 12, student database 11, which are accessed via the units of respective subsystems which are associated with said databases.

The function performed by the software and hardware complex of the remote training subsystem 5 using the above-mentioned units, AWS and databases is: training process support by the LMS system: workstations for students and tutors for viewing the schedule of their training activities, browsing the training materials, performing training tasks and checking the latter.

Management of individual educational trajectories (IC-individual curricula) starts with digitizing documents confirming previous education of the student and their uploading into a special table of the student database via the web page. Then the structure and subjects of the Basic Curriculum (BC) are downloaded from a special report into an xls file, an individual trajectory (individual curriculum-IC) is formed in the latter and is uploaded via the same report into a special separate table of ICs. After the IC is uploaded, it is verified by the data integrity control means according to the integrity rules.

Requests from students may be received via different communication channels:
an application from a student MA;
submissions to the Rector's Record Book;
requests via the official contact phone number of User (student) Support Service; and
request via operators' phone number.

Using a request transmission means, the student sends a request to be granted access to a training material and a tutor whom he/she has selected from the database. Any request from a student is automatically translated into a request (application) of ticket management system iTop (iTop. MySQL, PHP).

Requests from the students are processed by means of the request classification unit taking into account all information on a given student. After carrying out the analysis, the request classification unit resolves the request. As a result, the student is granted access to the necessary materials and chooses the training mode by his/her own means. Knowledge testing is carried out within the dates set by the training process support and academic performance record subsystem 4 and training process planning subsystem 3 using the MA and the AWS.

The data analysis unit, the data collection and sorting unit of the software and hardware complex of the training analytics subsystem 8 enable the collection, transmission and storage of digital footprint of each action of each student and each tutor. By means of the decision making data preparation unit, digital footprints provide information to the algorithm validation and processing unit to create a support scenario.

Functions performed by the software and hardware complex of the data integrity control subsystem 6 are:
to identify inconsistencies which occur in any of the subsystems or any unit of the system, and
to inform the staff on data inconsistencies in all subsystems for rapid response and correction of the occurring errors.

Data integrity control subsystem 6 collects data from all subsystems and means which provide for the functioning of the online training system in accordance with the sets of Data integrity rules provided for each of the subsystems, cross-checks the data and notifies the identified errors to the respective subsystems for their rectification. The data mirroring unit of the unified corporate information model (a scheme in Oracle DBMS with meta descriptions of all entities and attributes and mirror copies of data implemented in the form of Oracle view, materialized view or tables, with dblinks passed over into non-Oracle systems (PostrgreSQL, MySQL)) acquires the data and dynamics of their changes from all subsystems. The data integrity rule meta description unit (a scheme in Oracle DBMS, rules are stored in the form of SQL queries) has access to data integrity rules. The data integrity problem visualization unit transmits analytical reports on data integrity problems prepared by the data integrity rule periodic control unit to AWS of managers who are responsible for data integrity in the different subsystems.

The data integrity control subsystem 6 is also capable of updating the status of user databases and their verification in online mode. A CRM with the contact center and student, tutor and employee member areas constructed on the basis thereof provides support for interaction between the students, the tutors and the employees who support the training process. Control of components of the data integrity control subsystem 6 is implemented on the basis of identification of multiply repeated (regular) and interconnected types of activities (processes, sub-processes, procedures) which convert various resource types into the necessary results and define the boundaries of functional responsibilities of subdivisions. This is done by using process decomposition (division) into procedural units with various extents of explicitation.

Data from all IS generated for the logical entities are provided into the separate system “Infomodel” with a full description of entities and their attributes (fields).

For automatic verification and displaying of revealed error in data and entities of “Infomodel” a special report “800 Executive Workspace” has been developed. This report reflects all sub-reports on data integrity verifications in the entities of the “Infomodel” and displays statistics on the occurrence of errors and warnings on different levels which are automatically collected. It is also possible to update statistics data. Each integrity rule (and the report associated therewith) is linked to one entity to be verified, which, in its turn, is linked to one subdivision which is responsible for rectifying the data in this report (entity).

The whole list of necessary operations and necessary means for implementation is described in detail in respective regulations and procedure checklists.

To facilitate the explanation of this invention, it has been described as a system, i.e., as a device, however it should be appreciated that this invention may be implemented in the form of methods which correspond to the subsystems, and programs which represent the methods.

It will be apparent for a person skilled in the art that the implementation of the inventive online higher education system capable of training a user via a network is possible by using known hardware and software means, as well as by using respective novel hardware and software means which are particularly created to implement the inventive system.

The claimed online higher education system relates to the field of education, it may be used for training in both higher educational establishments and for occupational retraining, professional development of specialists.

1. An online higher education system comprising:
mutually interacting subsystems that comprise:
a marketing and applicant attraction subsystem,
a remote admission subsystem,
a training process planning subsystem,
a training process support and academic performance record subsystem,
a remote training subsystem, and
a data integrity control subsystem configured to provide data integrity and quality,
wherein the subsystems are integrated by a common IT infrastructure including interfaces for interaction with external systems and at least three databases including a content database, a tutors database, and a students database;
wherein the subsystems are software and hardware complexes which include data acquisition, processing, transmitting means, as well as mutual interconnection means, the subsystems integrated and/or connected as follows:
the marketing and applicant attraction subsystem has its output connected to the remote admission subsystem and the training process planning subsystem;
the remote admission subsystem has its output connected to the training process support and academic performance record subsystem, the training process planning subsystem, and the remote training subsystem;
the training process support and academic performance record subsystem and the training process planning subsystem are integrated by a two-way communication, wherein the training process planning subsystem has its output connected to the remote training subsystem, and the remote training subsystem has its output connected to the training process support and academic performance record subsystem;
the training process support and academic performance record subsystem has its output connected to external users of the system;
the remote training subsystem has its output connected to the external users of the system; and
the data integrity control subsystem is connected to inputs and outputs of all subsystems.

2. The system of claim 1, wherein the subsystems further comprise a training content development subsystem.

3. The system of claim 1, wherein the subsystems further comprise a training analytics subsystem, and the IT infrastructure of the system further comprises a digital footprint database.

4. (canceled)

5. The system of claim 3, wherein the subsystems are coupled to further subsystems as follows:
the training process planning subsystem has its output connected to the training content production subsystem, which has its output connected to the remote training subsystem via the content database;
the training process support and academic performance record system is connected to the training analytics subsystem by a two-way communication;
a second input of the training analytics subsystem is connected via the digital footprint database to the remote training subsystem;
an input of the training content production subsystem is connected to a second output of the training analytics subsystem; and
the data integrity control subsystem is connected to the inputs and outputs of all subsystems.

6. The system of claim 1, wherein the marketing and applicant attraction subsystem includes:
an advertising campaign management unit having its output connected to the lead generation unit;
a lead processing unit having its input connected to the lead generation unit and the external lead generation unit;
an output of the lead processing unit connected to a telephone interaction control unit and an e-mail interaction control unit, which has its output connected to the lead processing unit; and
an output of the telephone interaction control unit connected to a “low-quality lead” status assignment device and a lead to contact conversion device,
wherein units and devices of the marketing and applicant attraction subsystem are coupled to specialist automated workstations (AWS).

7. The system of claim 1, wherein the remote admission subsystem comprises:
a competition unit which includes multiple competition test units with proctoring and entrance test holding devices;
a member area registration device;
applicant digital twin processing devices including devices for primary verification of applicant documents, applicant registration, receiving an admission request, generating an applicant's individual curriculum (IC) project, consent provision, contract signing and payment, document receipt, and onboarding; and
transfer student digital twin processing devices including devices for primary verification of transfer student documents, IC project generation, transfer student registration, contract signing and payment, document receipt, and onboarding via transfer.

8. The system of claim 1, wherein the training process planning subsystem includes:
a basic curriculum (BC) and groups register management unit, which has its input connected by a two-way communication with an individual curriculum (IC) generation management unit and connected, in combination with an output of the IC generation management unit, to optional/elective courses registration and final certification (FC) planning management units,
outputs of the optional/elective courses registration and FC planning management units connected to a TS load calculation and distribution control unit,
an output of the TS load calculation and distribution control unit connected to a schedule generation and integrity checking control unit, and
an output of the BC and groups register management unit coupled to a BC development/actualization management and group making unit, an output of which is coupled to a BC and group correspondence management unit,
wherein units of the training process planning subsystem are coupled to specialist automated workstations (AWS).

9. The system of claim 1, wherein the training process support and academic performance record subsystem includes:
a voice inquiry processing unit;
a consultation providing unit;
a transcript and exam sheet generation unit; and
a position change unit,
wherein units of the training process support and academic performance record subsystem are coupled to specialist automated workstations (AWS).

10. The system of claim 1, wherein the remote training subsystem includes:
a content access grant unit;
multiple activity access units; and
a grade calculation unit,
wherein units of the remote training subsystem are coupled to specialist automated workstations as (AWS).

11. The system of claim 1, wherein the data integrity control subsystem includes:
a data mirroring unit of a unified corporate information model;
a data integrity rule meta description unit;
a data integrity rule periodic control unit; and
a data integrity problem visualization unit,
wherein units of the data integrity control subsystem are coupled to specialist automated workstations (AWS).

12. The system of claim 2, wherein the training content development subsystem includes:
a production schedule generation unit;
multiple content type assignment units;
multiple content structure element (CSE) content generation units;
a CSE correction unit;
multiple CSE media content generation units; and
multiple content packaging units,
wherein units of the training content development subsystem are coupled to specialist automated workstations (AWS).

13. The system of claim 3, wherein the training analytics subsystem includes:
a data collection and sorting unit;
a data analysis unit;
a student feedback analysis unit;
a decision making data preparation unit; and
an algorithm validation and processing unit;
wherein units of the training analytics subsystem are coupled to specialist automated workstations (AWS).

14.-16. (canceled)
